(19) United States
(12) Patent Application Publication
(10) Pub. No.: US 2009/0102929 A1
(43) Pub. Date: Apr. 23, 2009

(54) WEB CAMERA MODULE AND OPERATION METHOD THEREOF

(75) Inventors: Wen-Yi Su, Hsinchu City (TW); Jen-Tse Wang, Hsinchu City (TW)

Correspondence Address: J C PATENTS, INC., 4 VENTURE, SUITE 250, IRVINE, CA, 92618, US

(73) Assignee: FARADAY TECHNOLOGY CORP., Hsinchu (TW)

(21) Appl. No.: 11/875,272

(22) Filed: Oct. 19, 2007

(51) Int. Cl. H04N 5/225

(52) U.S. Cl. 348/207.1

(57) ABSTRACT

A web camera module and an operation method thereof are provided. The web camera module includes a sensor and a back-end circuit coupled to the sensor. The sensor provides an image signal. The back-end circuit receives a firmware program from a personal computer and executes the firmware program to perform an image processing on the image signal, and then the back-end circuit provides a result of the image processing to the personal computer.

### BACKGROUND OF THE INVENTION

1. Field of the Invention

The present invention generally relates to a web camera module and an operation method thereof, in particular, to a web camera module without a flash memory and an operation method thereof.

2. Description of Related Art

In recent years, the demands to multimedia products related to web communication has been increasing along with the widespread of web communication software, such as Windows Live Messenger or Yahoo Messenger etc, wherein web camera is one of the most popular multimedia products.

FIG. 1 is a schematic block diagram of a conventional web camera module. Referring to FIG. 1, the web camera module 100 includes a sensor 110, a back-end circuit 120, and a flash memory 130. The sensor 110 provides an image signal to the back-end circuit 120. The back-end circuit 120 processes the image signal. The flash memory 130 stores a firmware program of the web camera module 100. A universal serial bus (USB) 140 connects the web camera module 100 to a personal computer 150 and transmits an image processing result of the back-end circuit 120 to the personal computer 150.

The back-end circuit 120 includes a processor 121 and a memory 122. The processor 121 loads the firmware program from the flash memory 130 into the memory 122 and executes the firmware program to perform an image processing on the image signal, and then the processor 121 sends a result of the image processing back to the personal computer 150 via the USB 140.

Since the global demands to web cameras keep increasing, the cost of web cameras has to be reduced. The flash memory in a conventional web camera module increases both the cost and the volume of the web camera module therefore it has to be eliminated.

### SUMMARY OF THE INVENTION

Accordingly, the present invention is directed to a web camera module, wherein a firmware program is not stored in a flash memory but is directly downloaded into the web camera module from a personal computer, so that both the cost and the volume of the web camera module are reduced.

The present invention is directed to an operation method suitable for a web camera module provided by the present invention, wherein a firmware is not stored in a flash memory but is directly downloaded into the web camera module from a personal computer.

The present invention provides a web camera module including a sensor and a back-end circuit coupled to the sensor. The sensor provides an image signal. The back-end circuit receives a firmware program from a personal computer or a laptop computer and executes the firmware program to perform an image processing on the image signal, and then the back-end circuit provides a result of the image processing to the personal computer or the laptop computer.

According to an embodiment of the present invention, the back-end circuit in the web camera module includes a memory and a processor coupled to the memory. The memory receives and stores the firmware program. The processor executes the firmware program to perform an image processing and provides a result of the image processing to the personal computer.

The present invention provides a web camera operation method including following steps. First, a firmware program is received from a personal computer. Then, an image signal is received from a sensor. After that, the firmware program is executed to perform an image processing on the image signal. Finally, a result of the image processing is provided to the personal computer.

In the present invention, a firmware is directly downloaded from a personal computer instead of being stored in a flash memory. Accordingly, both the cost and the volume of a web camera module are reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a conventional web camera module.

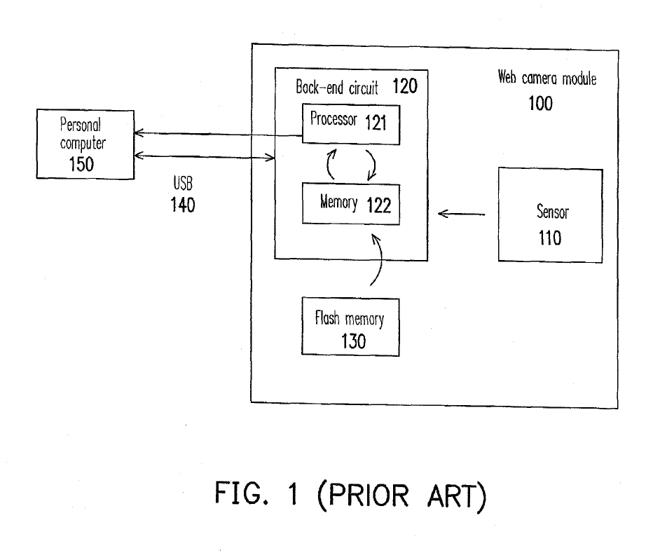

FIG. 2 is a schematic block diagram of a web camera module according to an embodiment of the present invention.

FIG. 3 is a flow chart of a web camera operation method according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

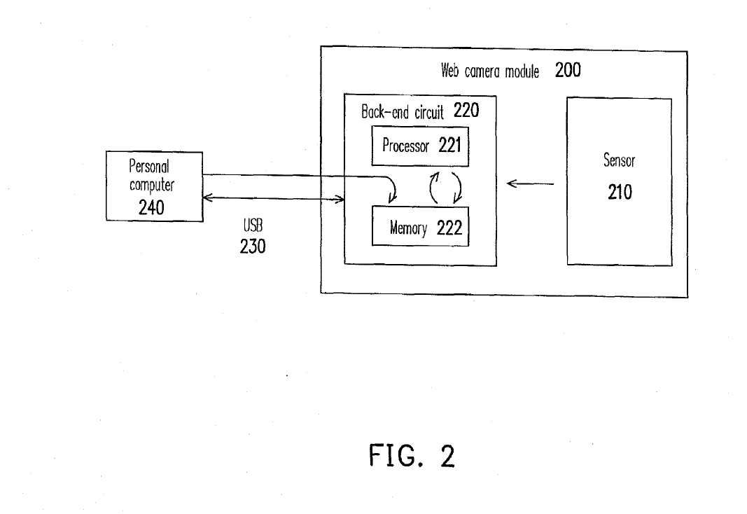

FIG. 2 is a schematic block diagram of a web camera module 200 according to an embodiment of the present invention. Referring to FIG. 2, the web camera module 200 includes a sensor 210 and a back-end circuit 220. The web camera module 200 can be mounted on a display of a personal computer 240. The sensor 210 provides an image signal to the back-end circuit 220. The sensor 210 may be a metal-oxide-semiconductor field-effect transistor (MOSFET) sensor or a charge-coupled device (CCD) sensor. In the present embodiment, the personal computer may be a laptop computer.

The back-end circuit 220 is coupled to the sensor 210. The back-end circuit 220 receives a firmware program from the personal computer 240 and executes the firmware program to perform an image processing on the image signal provided by the sensor 210, and then the back-end circuit 220 sends the image processing result back to the personal computer 240.

The back-end circuit 220 includes a processor 221 and a memory 222. The memory 222 receives and stores the firmware program. The memory 222 may be a static random access memory (SRAM). The processor 221 is coupled to the memory 222. The processor 221 executes the firmware program to perform the image processing, and the processor 221 provides the image processing result to the personal computer 240.

The firmware program is provided by a driver program executed by the personal computer 240. The driver program transmits the firmware program through a universal serial bus (USB) 230 when the personal computer 240 boots up. After that, the processor 221 receives the firmware program from the driver program and stores the firmware program into the memory 222, and then, the processor 221 executes the firmware program. Besides, if a different hardware design is adopted by the web camera module 200, the firmware program may also be directly stored in the memory 222 by the driver program and then executed by the processor 221. The firmware program conforms to USB video class (UVC) and/or USB audio class (UAC).

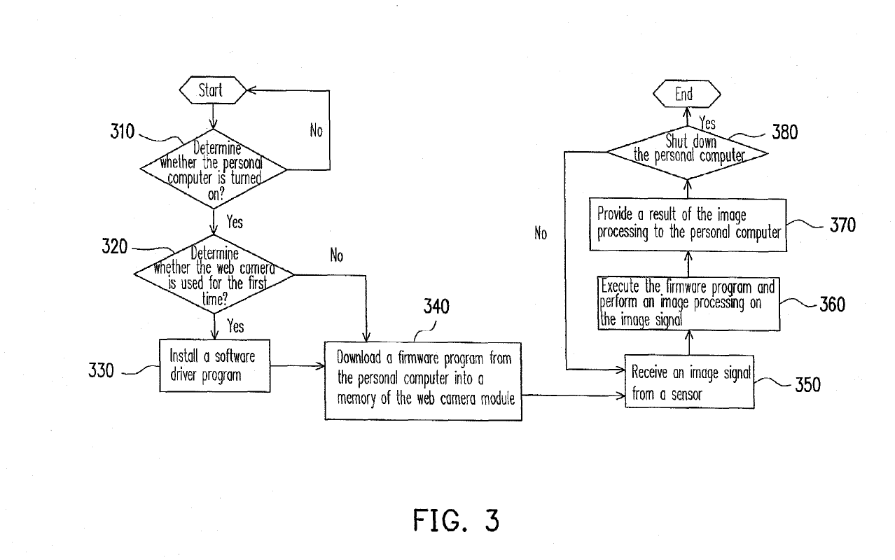

FIG. 3 is a flow chart of a web camera operation method according to another embodiment of the present invention. In step 310, whether the personal computer 240 is turned on is determined. If the computer is turned on, step 320 is executed; otherwise, the procedure returns to step 310. In step 320, whether the web camera is used for the first time is determined. If the web camera is used for the first time, it is determined that the driver program of the web camera has not been installed and accordingly the web camera cannot be used, thus, step 330 is executed to install the driver program of the web camera. If the web camera is not used for the first time, it is determined that the driver program of the web camera has been installed and step 340 is executed.

In step 340, a firmware program is downloaded from the personal computer 240 and is stored into the memory 222 of the web camera module 200. The firmware program is transmitted through the USB 230. After the firmware program is downloaded, the processor 221 receives an image signal from the sensor 210 in step 350. After that, in step 360, the processor 221 executes the firmware program and performs an image processing to the image signal. In step 370, the processor 221 provides the image processing result to the personal computer 240.

Here if step 380 is executed, the entire procedure of the web camera operation method is terminated by the shutdown of the personal computer 240; otherwise, the procedure returns to step 350 to repeat the steps for processing the image signal.

In summary, unlike the conventional technique wherein a firmware program is stored in a flash memory, in the present embodiment, the firmware program is directly downloaded from a personal computer and stored in a memory of a web camera module. Thus, in the present invention, the web camera module does not require any flash memory, and accordingly the cost of the web camera module is reduced. Moreover, by eliminating the flash memory, the volume of the web camera module is also reduced and the circuit layout thereof is simplified.

Furthermore, the transmission rate of USB is 480 Mbps per second, while the transmission rate of flash memory is 85 Mbps per second. Thus, the transmission speed is increased by downloading the firmware program from the personal computer through a USB. Accordingly, the time required for transmitting the firmware program is shortened and the power consumption of the laptop computer is reduced. In addition, the firmware program is easily updated since it is provided by a driver program of the personal computer instead of being stored in a flash memory of the web camera module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A web camera module, comprising:
a sensor, providing an image signal; and
a back-end circuit coupled to the sensor, receiving a firmware program from a personal computer, executing the firmware program to perform an image processing on the image signal, and providing a result of the image processing to the personal computer.

2. The web camera module according to claim 1, wherein the web camera module is mounted on a display of the personal computer.

3. The web camera module according to claim 1, wherein the personal computer is a laptop computer, and the web camera module is directly mounted on the laptop computer.

4. The web camera module according to claim 1, wherein the sensor is a metal-oxide-semiconductor field-effect transistor (MOSFET) sensor or a charge-coupled device (CCD) sensor.

5. The web camera module according to claim 1, wherein the back-end circuit comprises:
a memory, receiving and storing the firmware program; and
a processor coupled to the memory, executing the firmware program to perform the image processing, and providing the result of the image processing to the personal computer.

6. The web camera module according to claim 5, wherein the memory is a static random access memory (SRAM).

7. The web camera module according to claim 5, wherein the personal computer executes a driver program, and the driver program provides the firmware program.

8. The web camera module according to claim 7, wherein the driver program provides the firmware program when the personal computer boots up.

9. The web camera module according to claim 7, wherein the driver program provides the firmware program through a universal serial bus (USB).

10. The web camera module according to claim 7, wherein the driver program directly stores the firmware program into the memory.

11. The web camera module according to claim 7, wherein the processor receives the firmware program from the driver program and stores the firmware program into the memory.

12. The web camera module according to claim 1, wherein the firmware program conforms to USB video class (UVC) and/or USB audio class (UAC).

13. A web camera operation method, comprising:
receiving a firmware program from a personal computer;
receiving an image signal from a sensor;
executing the firmware program to perform an image processing on the image signal; and
providing a result of the image processing to the personal computer.

14. The web camera operation method according to claim 13, wherein the personal computer executes a driver program, and the driver program provides the firmware program.

15. The web camera operation method according to claim 14, wherein the driver program provides the firmware program when the personal computer boots up.

16. The web camera operation method according to claim 14, wherein the driver program provides the firmware program through a USB.

17. The web camera operation method according to claim 13, wherein the firmware program conforms to UVC and/or UAC.
